(19) United States
(12) Patent Application Publication
(10) Pub. No.: US 2013/0103592 A1
(43) Pub. Date: Apr. 25, 2013

(54) Interactive Licensing Of Media With Negotiation And Dynamic Pricing Guidance

(71) Applicants: Gary Shenk, Seattle, CA (US); Gilbert Gerard Wong, Redmond, WA (US); Katherine Mae Golden, Seattle, WA (US); Alison L. Cramer, Seattle, WA (US); Aaron Smith, Seattle, WA (US); Joshua Saint Jacque, Federal Way, WA (US); Jason Christopher Rudmann, Liberty Lake, WA (US)

(72) Inventors: Gary Shenk, Seattle, CA (US); Gilbert Gerard Wong, Redmond, WA (US); Katherine Mae Golden, Seattle, WA (US); Alison L. Cramer, Seattle, WA (US); Aaron Smith, Seattle, WA (US); Joshua Saint Jacque, Federal Way, WA (US); Jason Christopher Rudmann, Liberty Lake, WA (US)

(73) Assignee: CORBIS CORPORATION, Seattle, WA (US)

(21) Appl. No.: 13/277,174

(22) Filed: Oct. 19, 2011

(51) Int. Cl. G06Q 30/06; G06Q 30/00

(52) U.S. Cl. 705/80; 705/27.1; 705/26.7

(57) ABSTRACT

Embodiments are directed towards providing method for negotiating a license to a media item by a customer for a commercial use, including maintaining by a digital media licensing server a catalog of media items that are available to be licensed, and a database of records. Receiving a designation of a media item from the catalog, providing a customer interface that enables a customer to specify an offer to license the selected media item; receiving an offer, electronically providing to a plurality of rights holders in the media item information about the offer, receiving from rights holders at least one counteroffer price, determining a collaborative counteroffer price, and providing the collaborative counteroffer price to the customer. Additional embodiments are directed toward a method for making recommendations for alternative media items to license.

### TECHNICAL FIELD

Various embodiments generally relate to a digital media system that enables the use of electronic negotiation and recommendations for licensing digital media items.

### BACKGROUND

Online digital media systems enable customers to search for, select, obtain pricing and license digital media items to be downloaded for subsequent use. Uses for digital media include commercial uses such as music to accompany movies and videos, advertising, corporate events, incorporation into print publications such as newspapers and magazines, incorporation into online publications such as websites and blogs and personal uses, such as viewing movies and listening to music at home.

Online digital media systems (DMS) enable content providers, i.e. providers of digital media items, to make digital media available to customers for commercial uses across a network. Today there are many barriers that prevent professionals from using online DMS to obtain and license media items for commercial uses, including slow response times from rights holders, high costs, and a lack of self service capabilities to aid the research process. Further, in some area, such as the licensing of music for commercial uses, not all aspects of the licensing process may be performed electronically. For commercial music licensing, the presence of multiple entities that share the rights for media items, referred to herein as rights holders, has made it challenging to perform certain aspects of the licensing process, including determination of pricing and negotiation of prices among the rights holders. In particular, there is no single source for obtain updated pricing of media items for commercial purposes. Consequently, there is no agreed upon model for providing an initial price on which to base price negotiations.

As an example, a music synchronization license, commonly referred to as a sync license, is a music license that allows a license holder, or licensee, to “sync” music to some kind of media output. Often sync licenses are used for TV shows and movies but may also be required for presentations at corporate events and other commercial uses of media. Generally, any kind of visual paired with sound requires a sync license for the song(s) being used. Traditionally, a sync license is obtained from a music publisher, or thirds party clearance agency that obtains the necessary clearances or rights, while a master recording license must also be obtained by from the record label or owner of the master recording, or master.

A sync license is subject to a set of conditions or license terms such as how the song can be used, i.e. its commercial use, the geographic territory in which it will be used and during what period of time it can be used. However, there is no agreed-upon methodology or industry standard practice for pricing sync licenses. Record companies and music publishers have internal methodologies for such content ranking and classification, but these approaches are limited to the music and copyrights within their individual catalogues. However, the synchronization marketplace is much broader than the catalog of any single record company or music publisher. Thus, it would be advantageous if there was a method for scoring and classifying media items including songs that could be used as the basis for the pricing of sync licenses.

Further, it would be advantageous to provide a DMS that enables rights holders and customers to interactively negotiate the price and terms of a license, including a sync license, to use media items for selected commercial uses.

Currently, media licensing fees are only exposed to consumers where pre-priced assets are provided by a rights clearance agency, i.e. the company obtaining the licenses, for pre-approved uses. Prior art clearance systems don't provide pricing guidance in cases where the license fee for a media item is negotiable. Without pricing guidance customers don't have information that enables them to make a reasonable starting offer, or to understand whether the eventual, negotiated, license fee for a particular media item is within their budget.

Thus, it would be advantageous to provide a DMS that provides pricing guidance to customers for negotiation of license fees.

Thus, it is with respect to these considerations and others that the present invention has been made.

### SUMMARY OF THE DESCRIPTION

Various embodiments are directed towards online licensing of media items, including songs and photos, for commercial uses. A customer selects a media item to license and then specifies the intended commercial use and other licensing terms. In addition, if there is not a fixed price to license the media item for an intended commercial use then the customer may specify a offer price. A digital media licensing server (DMLS) enables the customer and the rights holders in the media item to electronically negotiate a license price. The customer then checks-out, i.e. pays for the license and gains access to the media item.

In one embodiment, the DMLS receives the customer offer and provides the offer to each rights holder in the selected media item. Each rights holder can review the offer and make a counteroffer. The DMLS receives the counteroffers and generates a collaborative counteroffer based on the various counteroffers provided by the rights holders. The DMLS provides the counteroffer to the customer who can make a counteroffer.

In one embodiment, the DMLS provides pricing guidance to both the customer and the rights holders during the process of negotiating a price for a license to use a media item. Pricing guidance is based on a variety of intrinsic and extrinsic factors. In one embodiment, price is based on a score calculated for the media item where the score is calculated as a function of factors including the selected use, additional license terms, license history, and popularity. In some embodiments, media items are classified into tiers that are used to set base prices for media items. The DMLS calculates a price recommendation for the initial customer offer. Further, when the customer or a rights holder specifies an offer or counteroffer the subject invention provides guidance in the form of a text message that indicates the likelihood that the other party will accept the offer or counteroffer.

Various embodiments are directed towards providing recommendations of songs and artists that the customer may select. The recommendation is based on the likelihood of negotiating a license to a song, or artist's song, for a specified commercial use. In some embodiments the likelihood of licensing a song is based on the license history of the song from its rights holders, on its pre-approval status, or on the customer's budget for licensing the song.

### BRIEF DESCRIPTION OF THE DRAWINGS

Non-limiting and non-exhaustive embodiments of the present invention are described with reference to the following drawings. In the drawings, like reference numerals refer to like parts throughout the various figures unless otherwise specified.

For a better understanding of the present invention, reference will be made to the following Detailed Description of the Preferred Embodiment, which is to be read in association with the accompanying drawings, wherein:

FIG. 1 is a generalized block diagram of a preferred embodiment of an online digital media system (DMS) in which a digital media licensing server (DMLS) enables a customer to license a digital media item for commercial use from one or more rights holders.

FIG. 2A illustrates one embodiment of a customer user interface that enables a contributor to obtain pricing, negotiate pricing, make a counteroffer and license a digital media item for commercial use.

FIG. 2B illustrates one embodiment of a customer user interface that enables a contributor to obtain pricing, negotiate pricing, make a counteroffer and license a digital media item for commercial use.

FIG. 2C provides one embodiment of a customer user interface that enables a customer to respond to a counteroffer made by one or more rights holders to an offer to license a song for a commercial use previously made by the customer.

FIG. 2D provides one embodiment of a customer user interface that enables a customer to proceed with the purchase or license of a song after his/her offer is accepted by the rights holders.

FIG. 3A is an embodiment of a user interface used by a rights holder to review and then approve or make a counteroffer to an offer made by a customer to license a song for a specific use.

FIG. 3B is an embodiment of a user interface used by a rights holder to review and then either accept or decline a final offer made by a customer to license a song for a specific use.

FIGS. 4A-C are an overall flow diagram that depict the steps performed by a customer computer, a digital media licensing server and one or more rights holders to enable a customer to license a media item for a commercial use.

FIG. 5A provides a flow diagram that describes one embodiment of a method for calculating a recommended offer price for a license to use a media item for a specified commercial use.

FIG. 5B provides a flow diagram that describes one embodiment of a method for recommending media items for licensing by a customer for a specified commercial use.

FIG. 6 is a system diagram that shows components of one exemplary environment in which the invention may be practiced.

FIG. 7 is block diagram of the exemplary software modules of a digital media licensing server (DMLS).

### DETAILED DESCRIPTION

The invention now will be described more fully hereinafter with reference to the accompanying drawings, which form a part hereof, and which show, by way of illustration, specific exemplary embodiments by which the invention may be practiced. This invention may, however, be embodied in many different forms and should not be construed as limited to the embodiments set forth herein; rather, these embodiments are provided so that this disclosure will be thorough and complete, and will fully convey the scope of the invention to those skilled in the art. Among other things, the invention may be embodied as methods, processes, systems, business methods or devices. Accordingly, the present invention may take the form of an entirely hardware embodiment, an entirely software embodiment or an embodiment combining software and hardware aspects. The following detailed description is, therefore, not to be taken in a limiting sense.

As used herein the following terms have the meanings given below:

Media item—means a unit of information that can be licensed for use by a licensee. Example media items include inter alia a song, a record album or CD, a photograph, a movie and a video.

Digital media item—while the present invention pertains to media items stored in analog or digital format, in some cases the invention handles a media item in digital format specifically, in which case it is referred to as a digital media item. A digital media item can be referred to, displayed, played, downloaded across a network and licensed. Digital media includes digital music and digital sound files, digital photographs, commonly referred to as “digital images” or simply “images”, digital videos, vector art, animation files such as ADOBE FLASH files, and the like. For embodiments discussed herein, digital media items may comprise content that was originally created digitally, or content that was converted from analog to digital format.

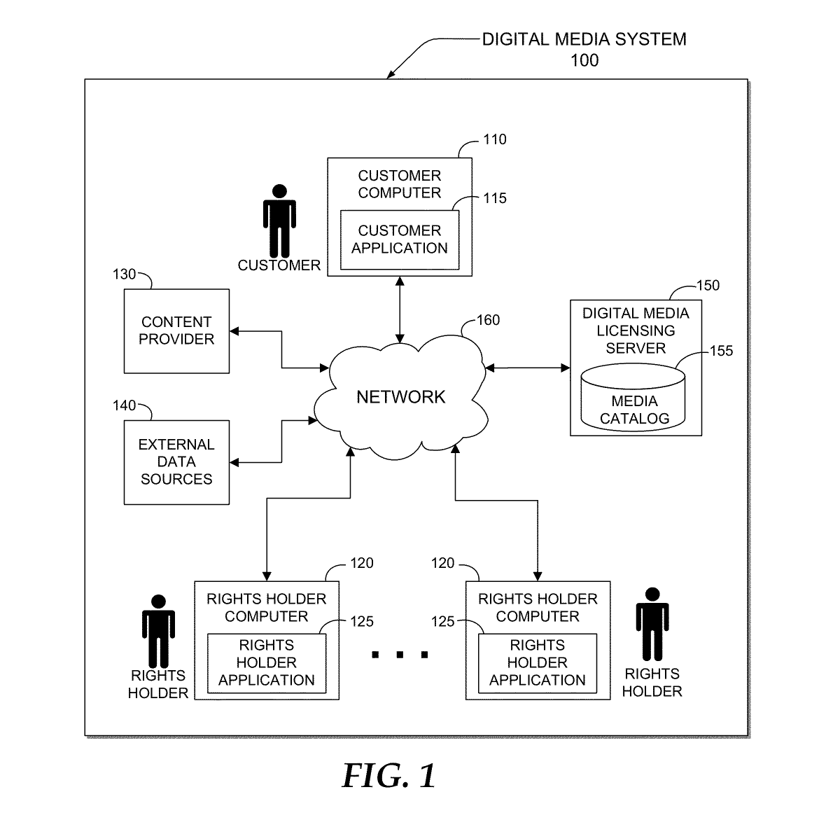

Media catalog—means a collection of media items, or references to media items, provided by a digital media system that are available for licensing from rights holders by a customer. The digital media system described herein with reference to FIG. 1 provides such a media catalog. Examples of media catalogs include a stock photo catalog, a stock video catalog, and a music catalog.

Customer—means an individual that uses a mobile device, PC or other electronic device to access a website or other service available across a network, to search for and potentially license media items offered by a DMS.

Content provider—means a person or entity that provides media items, or information about media items to a digital media system for inclusion in a media catalog. A contributor may be an owner of the digital media items or a representative of an entity that owns the digital media items.

Rights holder—means a person or entity that holds at least one right in a digital media item. Such rights may include inter alia copyrights, percent ownership, publishing rights, and ownership of a master copy of the digital media item.

Clearance agency—means an entity that manages and/or operates a system or service that enables customers to obtain and pay for licenses to use media items for selected uses. Typically, the clearance agency receives a commission or percentage of each license fee.

Some of the examples provided herein are constrained to catalogs of music that include only recorded music such as songs. However, the methods, processes, and systems described herein can be applied to media catalogs that include any type of media or content, including, inter alia, images, music and sound, video, movies, graphics, web pages, and text documents.

### Generalized Operation

The operation of certain aspects of the invention is described below with respect to FIGS. 1-7.

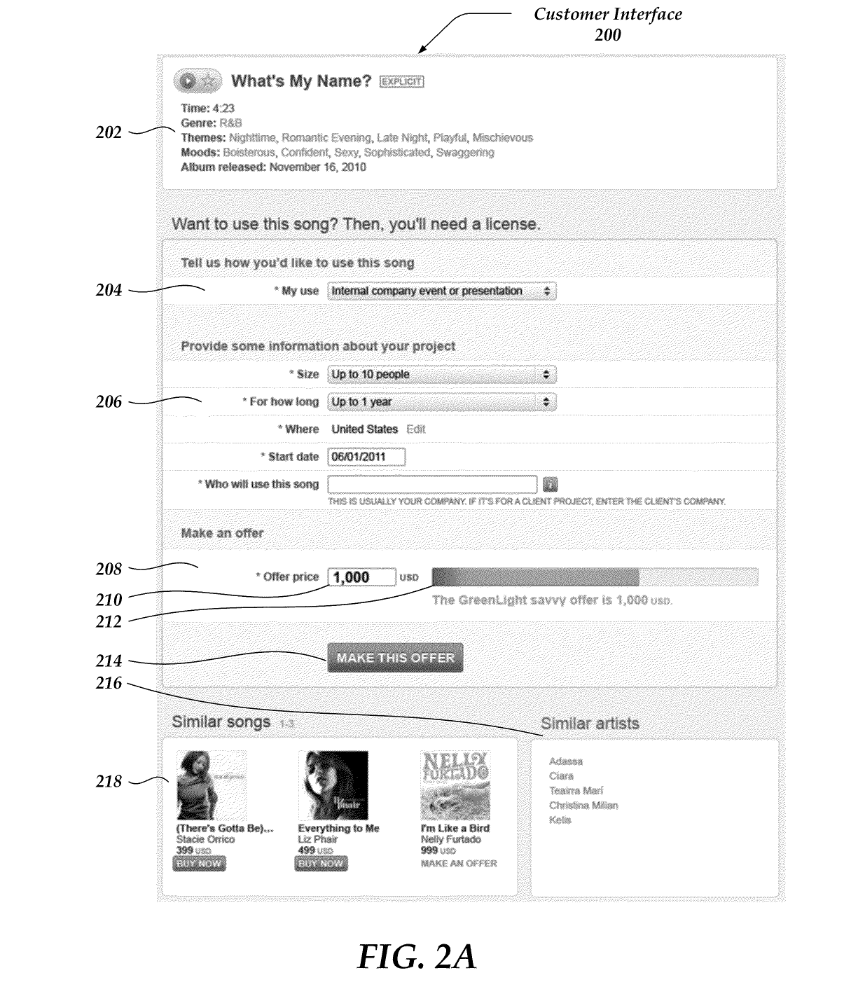

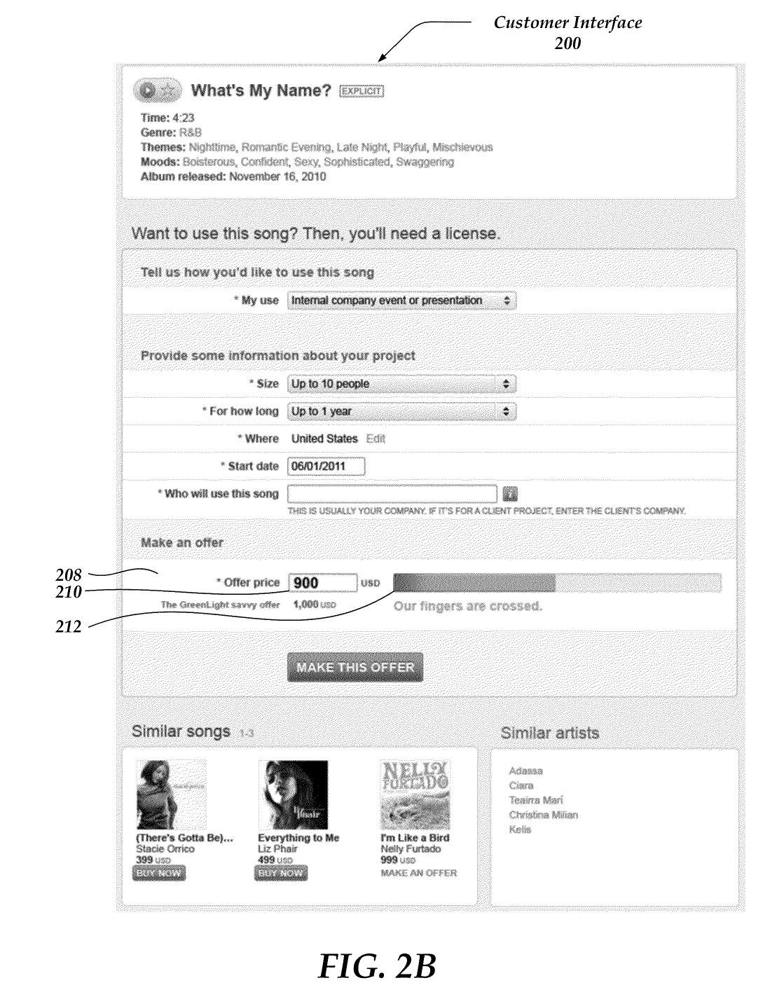

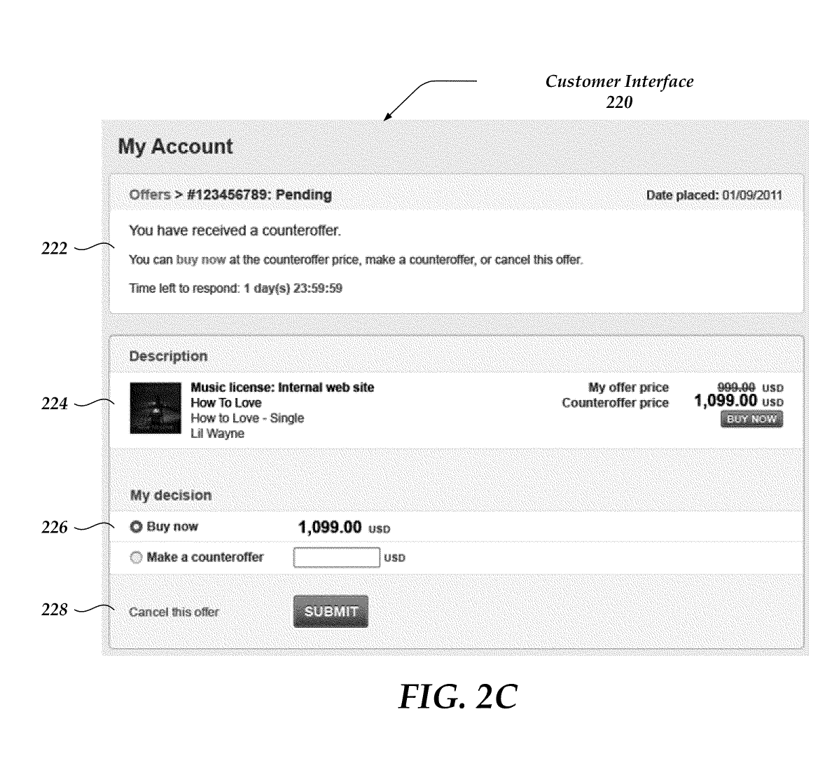

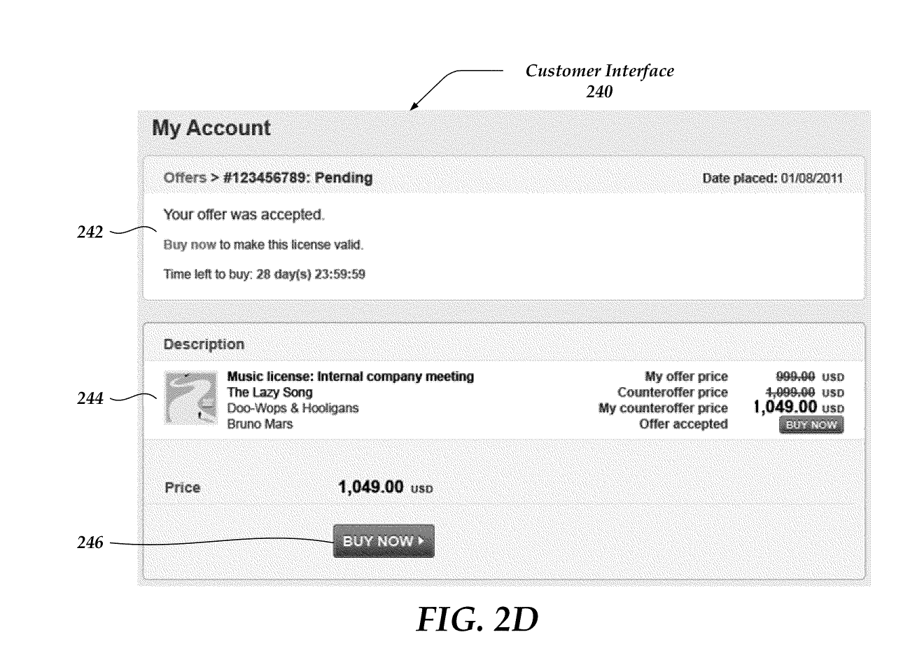

FIG. 1 is a generalized block diagram of a preferred embodiment of an online digital media system (DMS) in which a digital media licensing server (DMLS) enables a customer to license a media item for commercial use from one or more rights holders. A customer uses a customer application 115 that runs in a customer computer 110 to perform some or all of the following functions: search for, select, negotiate rights and pricing, license, purchase and download a media item. Customer application 110 is described in further detail hereinbelow with reference to FIGS. 2A-D.

Media items are listed in media catalog 155, which is managed by a digital media licensing server (DMLS) 150. DMLS 150 makes media items available for searching, browsing and licensing by customers. In some embodiments, media items are stored by DMLS 150 in digital format, as digital media items, and can be downloaded for commercial use after a customer first secures a license to use the digital media item. In other embodiments, DMLS 150 does not store the media item and these are obtained by the customer after the customer has secured a license. DMLS 150 provides services across a network 160 to customer computer 110, rights holder computer 120, and content provider 130.

Typically, information about a media item to be included in media catalog 155 is provided by a content provider 130 who typically is or represents one or more of the rights holders in the media item; for example, in the case of a digital photo it may be the photographer who owns the copyright to the photo that provides the photo for inclusion in media catalog 155. In the case of a song it may be the owner of the song master.

Each rights holders has a partial, or undivided right in each digital media item in which they are a rights holder. As described herein, each rights holder receives a percentage of the licensing revenue paid by the customer for licensing the digital media item for commercial use. To be clear, not all rights holders receive a percentage of the licensing revenue paid for each media item included in media catalog 155. Rather, for each media item, there is one or more rights holder that shares in the licensing revenue. As is discussed hereinbelow, DMLS 150 stores information about the revenue sharing arrangement among the various rights holders and other licensing information for each media item included in media catalog 155.

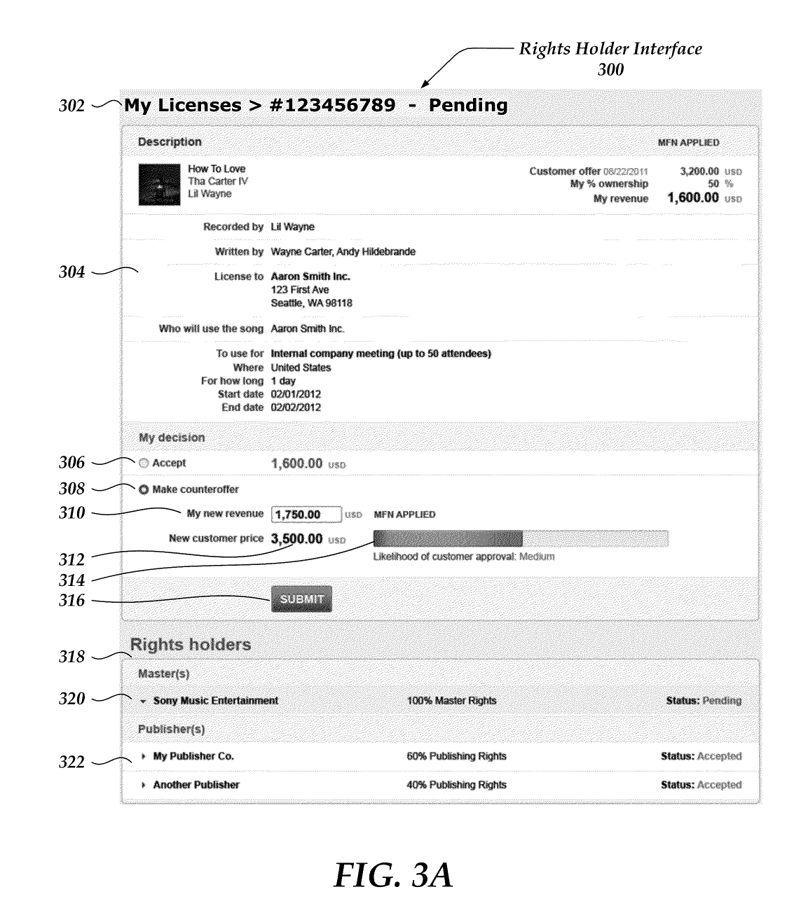

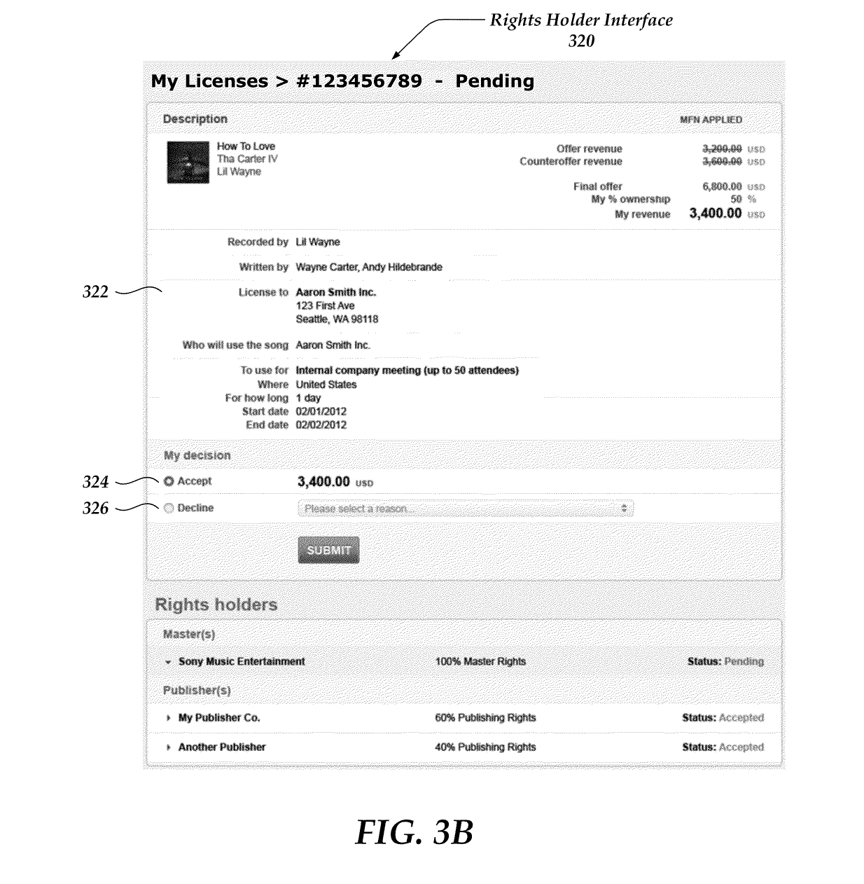

In one embodiment, a customer makes an offer, using customer application 115 to license a media item for a commercial use. DMLS 150 receives the offer and provides versions of the offer to each rights holder. Using a rights holder application 125 running on a rights holder computer 120 a rights holder views an incoming offer and responds to the offer. Rights older application 125 is further described hereinbelow with reference to FIGS. 3A-B.

In one embodiment, DMLS 150 determines a recommended price for a media item based on a variety of information. Information from one or more external data sources 140 may taken into account by DMLS 150 when determining a recommended price Examples of external data sources 140 include a social network account, such as a FACEBOOK account, for a recording artist, a computer server or search engine that provides information about web traffic to a website or web page, and repositories that track sales and popularity of songs, in the form of charts, lists, tables or database entries.

DMS 100 may additionally include an administrative user, an administrative computer and an administrative computer application. (not depicted or otherwise discussed herein).

FIGS. 2A-D are embodiments of the customer user interface provided to a customer by customer application 115 running in customer computer 110. In one embodiment, each of FIGS. 2A-2D correspond to an interactive Web page that is provided by DMLS 150 to customer computer 110 to be displayed by customer application 115.

FIG. 2A illustrates one embodiment of a customer interface 200 that displays a recommended offer price and enables a customer to make an offer to license a song for a specific commercial use. An information box 202 displays information about a song that a customer has previously selected. The information displayed includes the artist, song title, song length, genre of music, the various moods of the song and the release date of an album that includes the song. A use field 204 enables a customer to select an intended commercial use for the song. In the example provided by FIG. 2A, the selected use is for an internal company event or presentation. Other uses may include: background music for a television advertisement, music for a web page, or use in a movie or a video.

A project information box 206 enables a customer to specify additional information about the project that the song will be used for. Project information fields include the number of project staff that will use the song, how long the song will be used, the geographic area in which the song will be used, the starting date when the song will be used commercially, and s designation of who will use the song, for example this may be a client that is paying for the project.

An offer box 208 displays an entry field 210, and a bar graph 212. Initially, entry field 210 shows a recommended offer and bar graph 212 graphically illustrates the amount of the recommended offer. In one embodiment, a suitable text message displays beneath bar graph 212. Entry field 210 enables the customer to type in new or revised offer. The term “offer” is used synonymously with the term “price” herein. In a preferred embodiment, when the customer revises his/her offer using entry field 210 bar graph 212 and its corresponding text message update automatically. An example of a bar graph and message for a revised offer is given in FIG. 2B.

When the customer finishes specifying an offer, he/she uses an offer control 214 to submit the offer to DMLS 150 for further processing.

DMLS 150 also determines one or more media items, in this case songs, that are similar to the selected media item, or song. Similar songs are presented in panel 218. Similar songs may include songs with a fixed price; these have a “Buy Now” control underneath them. Alternatively, similar songs may also include one that do not have a fixed price and where the customer must make an offer to license the song for a specific use for a specific price; these are have a “Make an Offer” control beneath them. If more similar songs are available than can be shown in panel 216 then scroll buttons or another user interface technique is used to enable the user to view and select from among the similar songs determined by DMLS 150.

DMLS 150 also determines one or more artists whose media items, e.g. songs, are similar to the selected media item, or song. Similar artists are presented in panel 216. If more similar artists are available than can be shown in panel 216 then scroll buttons or another user interface technique is used to enable the user to view and select from among the similar artists determined by DMLS 150.

FIG. 2B illustrates one embodiment of a customer user interface that enables a contributor to obtain a recommended price, and make an offer to license a digital media item for a commercial use. In particular, FIG. 2B illustrates how customer interface 200 enables a customer to change the recommended offer price.

In FIG. 2B, the customer has entered an offer of $900 U.S. dollars (USD) in entry field 210. As a consequence, bar graph 212 has been updated to indicate a lower price and the text message below bar graph 212 has changed to “Our fingers are crossed.”

In one embodiment, if the customer makes an offer that is lower than a lower threshold then customer application 115 will not make the offer. Table 1 explains the various price ranges, relative to the recommended offer (RO), the message displayed for each price range, and whether or not the offer will be forwarded by customer application 115. For example, according to Table 1, if the offer made by the customer is 0.6 X the recommended offer, or 0.6RO, then this falls in the price range of 0.5RO<Offer<=0.75RO and the message “That's a little dicey” will be displayed.

FIG. 2C provides a customer user interface that enables a customer to respond to a counteroffer made by one or more rights holders to an offer to license a song for a commercial use previously made by the customer using customer interface 200. Using a customer interface 220 the customer can accept the counteroffer or make his/her own counteroffer. An information panel 222 provides information to the customer, in this case indicating that the customer has received a counteroffer and explaining the various options available to him/her. A description window 224 provides information about the counteroffer, including the name of the song, the artist, the selected commercial use, the original offer price and the counteroffer value.

A set of offer controls 226 enable the customer to indicate if he/she wishes to buy, or license, the song at the counteroffer price or to counteroffer at a new price. Finally, a set of submit controls 228 enable the customer to submit a counteroffer or to cancel the counteroffer.

FIG. 2D provides one embodiment of a customer user interface that enables a customer to proceed with the purchase or license of a song after his/her offer is accepted by the rights holders. Customer interface 240 displays the offer information and enables the customer to proceed with the purchase. An information panel 242 provides information to the customer, in this case indicating that the customer's offer was accepted and how much time remains for the customer to make the purchase. A description window 224 provides relevant information including the name of the song, the artist, the selected commercial use, the original offer price and any counteroffer amounts as well as the amount of the offer that was accepted by the rights holders.

A purchase control 246 enables the customer to proceed with the purchase or to cancel the purchase. After selecting purchase control 246 the customer is taken to a checkout interface where he/she provides method of payment information. Once the customer completes checkout, he/she is provided with or provided access to the media item. In one embodiment, after successful checkout the customer can download the media item in digital format. In another embodiment, DMS 100 notifies the customer when the media item is available and provides information about how to obtain it.

FIGS. 3A-B are embodiments of a rights holder user interface provided to a rights holder by rights holder application 125 running in rights holder computer 120. In one embodiment, each of the interfaces depicted in FIGS. 3A-B correspond to an interactive Web page that is provided by DMLS 150 to rights holder computer 120 to be displayed by rights holder application 125.

FIG. 3A is an embodiment of a user interface used by a rights holder to review and then approve or make a counteroffer to an offer made by a customer to license a song for a specific use. A title bar 302 gives a unique identifier for the offer and indicates its status as pending.

A description window 304 displays information about an offer that a customer has made to license a song for a specific use. Information displayed in description window 304 includes the name of the song, the recording artist, the writers, the licensee name and address, the name of the person or entity that will use the song, the use for which the song is being licensed, the geographic location in which the license will apply, the duration of the license and its starting and ending date. Description window 304 indicates that a standard most favorite nation (MFN) royalty model applies and lists the customer offer amount, the percentage ownership of the rights holder and the revenue that will be paid to the rights holder if the offer is accepted. Under the MFN royalty model, commonly used for sync licenses, the holder of the master and the publishers, considered cumulatively, split any royalty paid. If a third party clearance agency manages the license then they receive a commission or percentage of the overall royalty and then the master holder splits the remainder with the publishers. Each publisher has a negotiated share of the collective amount allocated to the publishers.

The rights holder can accept the offer using a radio button control 306, or make a counteroffer by selecting a radio button control 308 and entering a new, presumably higher revenue in an entry field 310. In the example, the rights holder enters 1,750.00 into entry field 310 and in response, rights holder application 125 updates and displays new information in a customer price field 312 and a bar graph 314 and updates the message below bar graph 314 to read “Likelihood of customer approval: Medium.”

When the rights holder is ready he/she uses a submit control 316 to submit the counteroffer to DMLS 150 for further processing.

Rights holder interface 300 also includes a rights holder window 318 that lists each of the rights holders for the song. A first part of the list 320 shows the owners of the master. A second part of the list 322 shows the various song publishers. Rights holder window 318 also lists, for each rights holder, the percentage ownership of the rights holder as well as the status of its response to the offer.

FIG. 3B is an embodiment of a rights holder interface 320 used by a rights holder to review and then either accept or decline a final offer approve made by a customer to license a song for a specific use. In this embodiment, a customer can make two offers at most; that is, the customer can make an initial offer and then make a final counteroffer to a counteroffer made by the rights holders. In other embodiments, more or less counteroffers can be made by either the customer or the rights holder.

Rights holder interface 320 is identical to rights holder interface 300 with two exceptions. First, a description window 322 in rights holder shows the revenue to the rights holder that would have resulted from the initial offer of $3,200 made by the customer, the revenue that would have resulted from the first counteroffer made by the rights holders, the amount of the final offer made by the customer, the percent ownership of the rights holder and his/her corresponding revenue amount.

The second exception is that rights holder interface 320 enables the rights holder to either accept, using an accept control 324 or decline, using a decline control 326, the final offer.

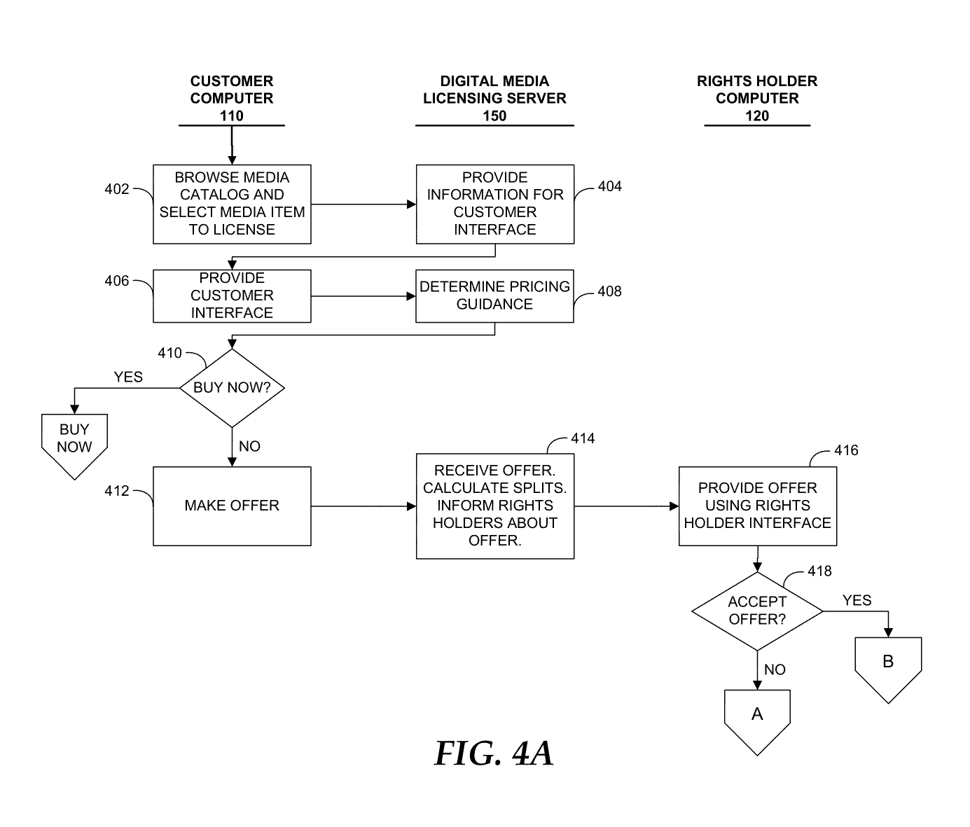

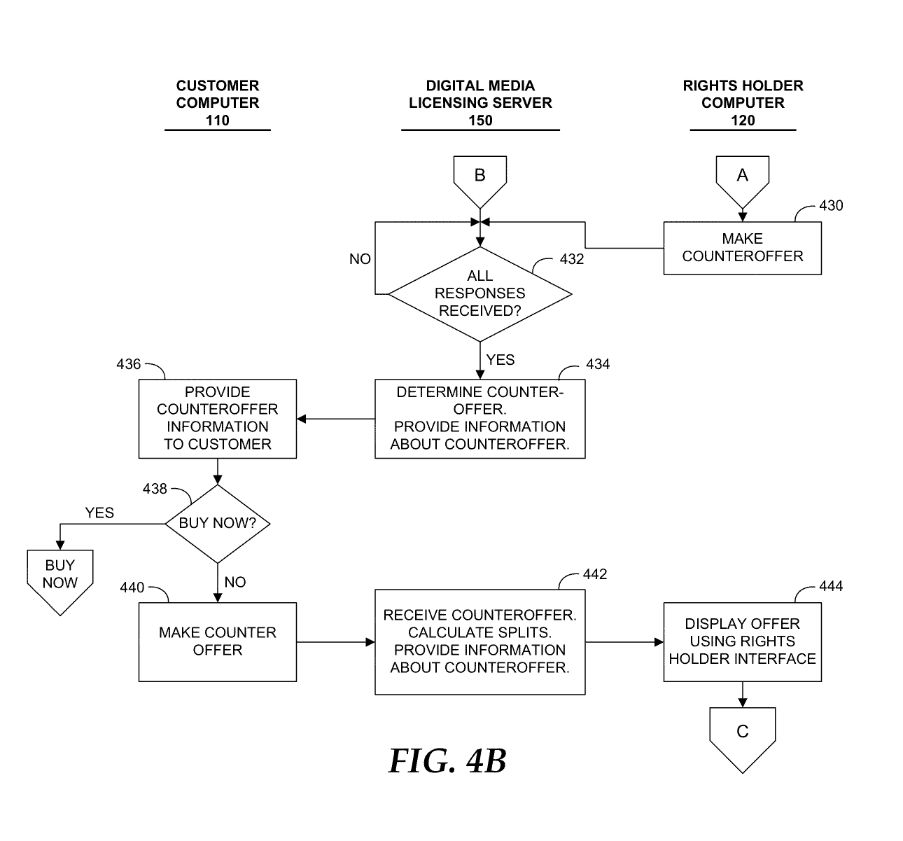

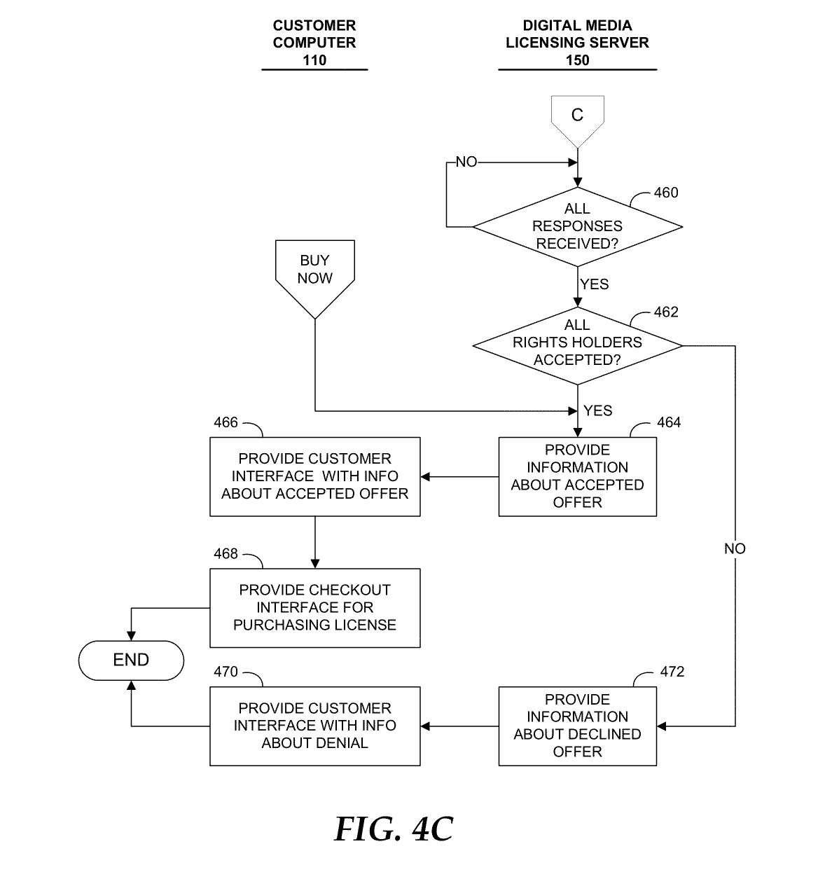

FIGS. 4A-C, 5 and 7 are flowcharts and component diagrams in which each graphical element, including rectangles, cylinders, and triangles, can be implemented by computer program instructions. These program instructions may be provided to a processor and then executed by the processor, thus creating means for implementing the actions represented by the graphical element. The computer program instructions may be executed by a processor to cause a series of operational steps to be performed by the processor to produce a computer-implemented process such that the instructions, which execute on the processor to provide steps for implementing the actions represented by the graphical element. Some of the computer program instructions may be performed in parallel, or across more than one processor, such as might arise in a mufti-processor computer system. In addition, the actions represented by one or more graphical elements may also be performed concurrently with actions represented by other graphical elements, or even in a different sequence than illustrated without departing from the scope or spirit of the invention. It will also be understood that the actions represented by each graphical element and by combinations of graphical elements can be implemented by special purpose hardware-based systems that perform the specified actions or steps, or combinations of special purpose hardware and computer instructions.

FIGS. 4A-C provide an overall flowchart that depicts the steps performed by a customer computer, a digital media licensing server (DMLS) and one or more rights holders to enable a customer to license a media item for a commercial use. The method begins at step 402 of FIG. 4A when a customer uses customer application 115 running in customer computer 110 to browse media catalog 155 and then selects a media item to license. In one embodiment, DMLS 150 provides customer application 115 as a Web application that runs in a Web browser in customer computer 110. Customer application 115 provides a variety of methods for a customer to select a media item. For example, customer application 115 may provide a browsing interface that browses related collections of media items, it may provide a keyword search facility and it may enable the customer to add media items to a digital lightbox and save the digital lightbox contents for subsequent use. At step 402 customer computer 110 sends a message to DMLS 150 that contains a unique identifier for the selected media item.

At step 404 DMLS 150 obtains information about the selected media item from media catalog 415, and provides it along with a customer interface, such as customer interface 200 of FIG. 2A, to customer computer 110. At step 406 customer application 115 running in customer computer 110 provides the customer interface to the customer. Once the customer interactively specifies use information 204 and project information 206, using an interactive user interface such as customer interface 200, customer computer 110 provides this information to DMLS 150.

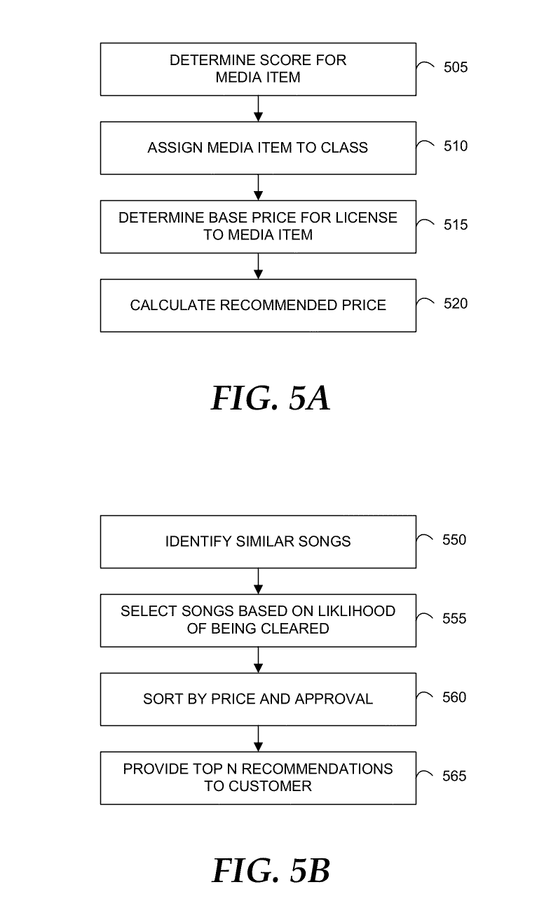

At step 408 DMLS 150 determines pricing guidance and provides it to customer computer 110, which in turn updates customer interface 200 by displaying the pricing guidance. Determining pricing guidance includes determining whether the media item is available for immediate purchase, at a fixed price referred to as the “buy it now” price. If no fixed license price has been established, i.e. there is no buy it now price, then the customer is allowed to make a price offer and DMLS 150 determines a recommended price. One embodiment of determining a recommended price is described with reference to FIG. 5.

At step 410, if the customer elects to accept a buy it now price, using customer application 115, then processing moves to off-chart reference Buy Now on FIG. 4C. If no buy it now price is available or if the customer elects not to use a buy now offer, then processing flows to step 412.

At step 412 the customer makes an offer using customer application 115 which, in turn, provides the offer to DMLS 150.

At step 414 DMLS 150 receives the customer offer, calculates the splits for each rights holder, and informs each rights holder in the selected media item about the offer. In a preferred embodiment, DMLS 150 transmits rights holder application 125 to rights holder computer 120 that contains the customer offer information. In an alternative embodiment, DMLS 150 sends an email message to the rights holder, at a designated email address, informing him/her that an offer for the selected media item has been received.

At step 416, the rights holder, at his/her convenience runs rights holder application 125 which provides information about the customer offer. At step 418, if the rights holder accepts the offer, using rights holder application 425, then processing resumes at step 432 of FIG. 4B. According to the embodiment given by rights holder interface 300, if the rights holder does not accept the offer, then he/she makes a counteroffer. In this case, processing resumes at step 430 of FIG. 4B where the customer makes a counteroffer. At step 430, as part of making a counteroffer, rights holder computer 120 sends information about the counteroffer to DMLS 150.

At step 432, DMLS 150 waits until it has received a message from rights holders either accepting the offer made by the customer or providing a counteroffer. In one embodiment, if a designated waiting period elapses DMLS 150 sends a message to each rights holder that hasn't yet responded. In a further embodiment, if at least one rights holder doesn't respond with a designated period, or after a designated number of notification attempts the offer is deemed to have not been accepted and the customer is so notified. In some embodiments, all rights holders must respond to an offer; in other embodiments less than all of the rights holders must response to an offer in order for the method to move forward to step 434.

At step 434 DMLS 150 determines an appropriate, collaborative, counteroffer to make to the customer, taking into account the various responses from rights holders that it received. In one embodiment, DMLS selects the highest counteroffer price sent from a rights holder computer 120 to serve at the value of the counteroffer. If all rights holders accept the customer offer than the value of the customer offer becomes the value of the counteroffer. Also at step 434, DMLS 150 provides information about the counteroffer, including customer interface 220, to customer computer 110.

At step 436 customer application 115 running in customer computer 110 provides the information about the counteroffer to the customer via a customer interface. The customer can either buy now, i.e. accept the counteroffer, or choose to make a counteroffer to the rights holders' counteroffer by specifying a value for the counteroffer. At step 438, a determination is made as to whether the customer chose to accept the counteroffer, i.e. buy now. If so, then processing moves to off-chart reference Buy Now on FIG. 4C. If not then at step 440 the customer makes a counteroffer using customer application 115 and customer computer 110 sends the counteroffer information to DMLS 150.

At step 442 DMLS 150 receives the counteroffer information from customer computer 110, calculates splits for each rights holder, and informs each rights holder in the selected media item about the offer.

At step 444, the rights holder, at his/her convenience then runs rights holder application 125 which provides the counteroffer. An example user interface that may be provided by rights holder application 125 for this purpose is rights holder interface 320. According to the embodiment of rights holder interface 320, each rights holder can either accept or decline the counteroffer. In this embodiment, no further price negotiation is allowed. As part of step 444, when a rights holder, using rights holder application 125, either accepts or declines a counteroffer a message is sent to DMLS 150 informing is as such.

Now reference is made to FIG. 4C where at step 460 DMLS 150 waits until it receives messages from each rights holder computer 120 informing it whether the corresponding rights holder has accepted or declined the counteroffer.

In one embodiment, at step 462, if all rights holders have accepted the counteroffer, then the counteroffer is deemed to have been accepted and processing continues at step 464. In this embodiment, if any of the rights holders have declined the counteroffer then the counteroffer is deemed to have been declined and processing continues at step 472.

At step 464, DMLS 150 provides information about the accepted offer, or counteroffer, to customer computer 110. Such information may include a customer interface such as customer interface 240. At step 466 customer computer 110 provides a customer interface such as customer interface 240 that includes the information about the accepted offer to the customer. According to customer interface 240, when the customer is ready to move forward and purchase the license he/she selects a buy now control 246. Then at step 468 the customer can purchase or buy the license to the selected media item at the last offer, or counteroffer, price using a checkout interface. The method then ends.

At step 472, if the counteroffer was declined by the rights holders, then DMLS 150 provides information about the declined offer, or counteroffer, to customer computer 110. Such information may include a customer interface analogous to customer interface 240 that informs the customer that the offer was declined. At step 474 customer computer 110 provides a customer interface analogous to customer interface 240 to the customer informing him/her that their offer or counteroffer has been declined. The method then ends.

### Price Calculations

Once the customer makes an initial offer, the DMLS 150 calculates each rights holder's share and a clearance agency's share, or commission. As used hereinbelow, DMLS 150 is considered as acting on behalf of the clearance agency that manages and/or operates DMS 100. The clearance agency receives a percentage, i.e. a share or commission, of the licensing fee paid by the customer. Rights holders are consequently presented with their revenue opportunity based on their percentage ownership. When one or more rights holders makes a counteroffer, the system recalculates the customer's license price or fee, which covers all fees applicable to each rights holder as well as that of clearance agency. DMLS 150 supports arbitrary percentage splits between the various participants (i.e. rights holders and clearance agency). In addition, the commonly used Most Favored Nation (MFN) allocation scheme is supported for song and music licenses, where all publishers (collectively) and the holder of the master recording are entitled to an equal share of royalties.

An example of the method used to calculate fees, or “splits”, as performed by DMLS 150 at various steps of the overall method described hereinabove with reference to FIGS. 4A-C, is presented in Tables 2-4. Table 2 describes an embodiment of the method used to calculate the various percentage allocation between the owner of the master recording, referred to as Master, and two publishers, referred o as Pub 1 and Pub 2 for an initial customer offer of $1000 under an MFN allocation scheme. In this example, Pub 1 receives 70% of the royalty allocated to publishers and Pub 2 receives 30%.

Table 3 shows an embodiment of a method for calculating splits for a counteroffer made by the rights holders. In this example, the publisher counteroffer represents the total amount to be received by publishers, i.e. the counteroffer by a publisher isn't just their own share. Thus, among the three counteroffers the counteroffer made by the owner of the master recording, $525, is the highest. Thus, the 70% of license revenue due to rights holders amounts to $1050 (i.e. $525 for Master and $525 to be split 70/30 among Pub 1 and Pub 2), the 30% allocated to the clearance agency amounts to $450 and the price to the customer is calculated as $1500. In another embodiment, a counteroffer might be calculated as the average counteroffer. It may be appreciated that there are many ways to determine a counteroffer from among a plurality of counteroffers made by the various rights holders and different such methods may be adopted without departing from the scope or spirit of the invention.

Table 4, below, shows the calculation of splits for a final customer counteroffer of $1200. The method used is identical to that illustrated in Table 2.

### Content Scoring, Classification and Price Recommendations

The present invention provides a robust methodology for scoring, classifying and recommending license prices for media items. The approach can be applied to all commercially available recorded music, and is not limited to the catalog of any specific supplier. Further the approach can be applied to other types of media including photographs, movies, television shows, movies and the like. This approach to scoring, classification and price recommendations for media items can be used to support the pricing, promotion, merchandising and advertising strategies of online and brick and mortar businesses operations that license media items for commercial use.

In one embodiment, scoring, classification and price recommendations are based on historical factors such as license history and also on extrinsic factors such as sales history and current popularity of a media item in social media. Further, scoring, classification and price recommendations can take into account these factors as they relate to related media items such as media items from the same artist or from similar artists and media items that have the same rights holders. An example of the factors that may be taken into account in determining a score, class, or recommended price for a media item is given in Table 5.

### Scoring a Media Item

Scoring is used to rank or otherwise differentiate individual media items in one or more dimensions. For example scoring might be used to order media items returned from a keywords search that would otherwise have the same position in the search results, thereby showcasing media items that are more likely to be selected by customers for licensing. Scoring is also used in the present invention as the basis for classification and price recommendations.

In one embodiment, the score for a media item is calculated according to Equation 1 below:

$$Score ( Item ) = ArtistTier ( Item ) + Keyword ( Item ) + {\sum }_{i = 1}^{n} ( ( PeakPosition ( Item ) ( Chart ( i ) ) ) + WeeksOnChart ( Item ) ( Chart ( i ) ) ) \qquad ( 1 )$$

where:

Score(Item)—is the calculated score of a media item,

ArtistTier(Item)—is the artist Tier from Table 5,

Keyword(Item)—is an estimate of current public interest based on the average number of monthly keyword searches on the media item as described in Table 5,

PeakPosition(Item)(Chart(i)))—is the peak position attained by the media item on a specific industry chart, Chart(i), as described in Table 5, and

WeeksOnChart(Item)(Chart(i))—is the number of consecutive weeks that the media item has remained on Chart(i), as described in Table 5.

### Content Classification

Once a media item is scored, it is mapped into a class, or category, scheme (for example A,B,C). The classes, which are also referred to as content classes, can be used to address groups of media assets simultaneously. For example, content classes may be used to price large numbers of media items by class, rather than individually.

In one embodiment, a table, such as Table 6, is used to assign each media item into one of three classes, A-B-C, based on its score.

### Price Recommendations

Price recommendations are a way to provide guidance to media users during the process of negotiating a license to a media item for a commercial use. Two distinct types of price guidance are provided: a recommended offer price is calculated and provided to a customer, and feedback, or guidance, to a rights holder that indicates the likelihood that an offer or counteroffer he/she makes will be accepted by the customer. As shown, for example, in elements 210 and 212 of FIG. 2A, a recommended offer is displayed to the customer at the outset of the licensing process. Further, beneath element 314 of FIG. 3A a message is displayed that indicates the likelihood of customer approval of a counteroffer.

FIG. 5A provides a flow diagram that describes one embodiment of a method for calculating a recommended offer price for a license to use a media item for a specified commercial use. In one embodiment, this method is used at step 408 of FIG. 4A. At step 505, DMLS 150 determines a score for the media item. In one embodiment, the method described with reference to Equation 1 is used, although it may be appreciated that other methods may equally be used without departing from the scope and spirit of the subject invention. Next, at step 510 the media item is assigned to a class based on the score determined in the preceding step. In one embodiment, a table-based classification method is used.

At step 515 a base price for a license to the media item for a specified commercial use is determined. In one embodiment, historical average license prices are based on a historical average price for licenses to media items within the same class for the same commercial use. Once the historical averages are computed, a table, such as Table 7 may be used to obtain a base price. In this example, the base prices to use a media item for an internal company meeting are given. Once the customer selects a media item for licensing, the base price is determined as a function of the class to which the media item has been assigned.

At step 520 a recommended offer price for a customer to license a specified media item for a commercial use under selected licensing terms is calculated. In one embodiment, the recommended offer is calculated by multiplying the base price by an adjustment value or, multiplier, for each selected license term. For example, Table 8, lists multipliers for specific license terms including audience (i.e. size of the audience), duration (of the license), and territory (covered by the license).

For example, if a license to use a media item, which is classified into the B class, for company meetings with an audience of up to 50 persons, over a period of 5 months in multiple countries is requested, the recommended offer price will be:

Recommended offer=$114 (Base)×1.5 (Audience)×1.75 (Duration)×2 (Territory)=$598.50

It may be appreciated that the scores, classes, and terms, cases and multipliers are configurable in real time, and may be adjusted as necessary to reflect changes in customer tastes and preferences, and updated data inputs such as chart positions and market prices.

As previously discussed, a second type of pricing guidance is a textual message provided to a rights holder that indicates the likelihood that a counteroffer he/she makes will be accepted by the customer. An example of this type of guidance is provided in FIG. 3A, element 314. Generally, if an offer by a customer is too low a message stating as such is displayed. At low offer values, a user is informed that the specified amount is too low, i.e. the media item cannot be cleared at that price, and that licensing is not possible. At high offer values, a user is informed that the amount being offered is likely to be accepted by the other party. As with the recommended offer, thresholds at which messages are determined may be configured. In one embodiment, a likelihood of customer acceptance message is determined, from historical license history data, as a function of the percentage increase offered by a rights holder over the customer offer. The actual threshold values for various messages is based on historical data. An example table, that associates a text message with various counteroffers is given in Table 9.

### Recommending Media Items and Artists

DMLS 150 provides recommendations regarding similar media items and similar artists, as illustrated in FIGS. 2A and 2B. A key distinction between the approach used by the present invention to recommend similar songs or similar artists is that whereas prior art recommendation systems attempt to recommend songs that a user will want to listen to or purchase or watch, the subject invention is concerned with identifying similar songs that have a high likelihood of being cleared given a specified commercial use and budget.

FIG. 5B provides a flow diagram that describes one embodiment of a method for recommending media items for licensing by a customer for a specified commercial use. With minimal modification the same method can be employed to recommend artists or other types of media, e.g. videos or photos.

At step 550 a set of similar songs are identified. In one embodiment, songs are determined to be similar if certain characteristics, typically specified in metadata either stored in a digital song file or which are stored separate from the media item in a media catalog such as media catalog 155, are identical or close. Music characteristics used in determining similarity that may be taken into account include genre, release date, artist, tempo and themes. In one embodiment, similarity is curated, i.e. assessed by human curators trained to make such a determination. In other embodiments, similar songs are determined automatically. In assessing similar performing artists metadata that may be taken into account when assessing similarity include artist genres, themes, moods and decades active. For photographs or digital images, attributes that may be taken into account in determining similarity include subject matter, feel, colorization, the type of licensing model (rights managed, royalty free), categorization such as editorial versus creative, and so on. Media items determined to be similar in this step form an initial pool from which recommendations are subsequently made.

At step 555 a subset of media items, those determined to be similar in the preceding step, are now selected based on the likelihood that they will be approved within a timely fashion for the specified use by the rights holders in the customer-selected media item. Examples of factors that may taken into consideration in assessing likelihood of clearance for each selected media item are presented in Table 10. In one embodiment, license history of the media item is used to assess the likelihood of timely approval. For example, if the average time for the rights holders in the selected media item to negotiate a license is significantly longer than the average across all media items the likelihood of timely approval is lower than for a media item where the average time for its rights holders to reach approval is shorter. Media items that are pre-approved for a customer-selected use and where the budget specified by the customer is adequate or where its rights holders have a history of responding quickly and flexibly to customer offers will typically be selected at this step. In one embodiment, a customer interface enables a customer to specify his/her budget for a project. In another embodiment, the budget may be estimated as the customer offer price (element 210 of FIGS. 2A and 2B).

At step 560 the media items selected in the preceding step are sorted by price and approval status. Thus, pre-approved media items where the fixed price is within range of the customer offer are sorted at the top while media items that are not pre-approved whose price is higher than the customer offer are at the bottom. When no fixed license price has been established the price recommendation calculated at step 520 of FIG. 5A is used as the price. Finally, at step 565 the top N recommended media items, i.e. as many as fit within the customer user interface, are provided to the customer interface for presentation to the customer. For example, in customer interface 200 three song recommendations are presented to the customer (element 218 of FIG. 2A).

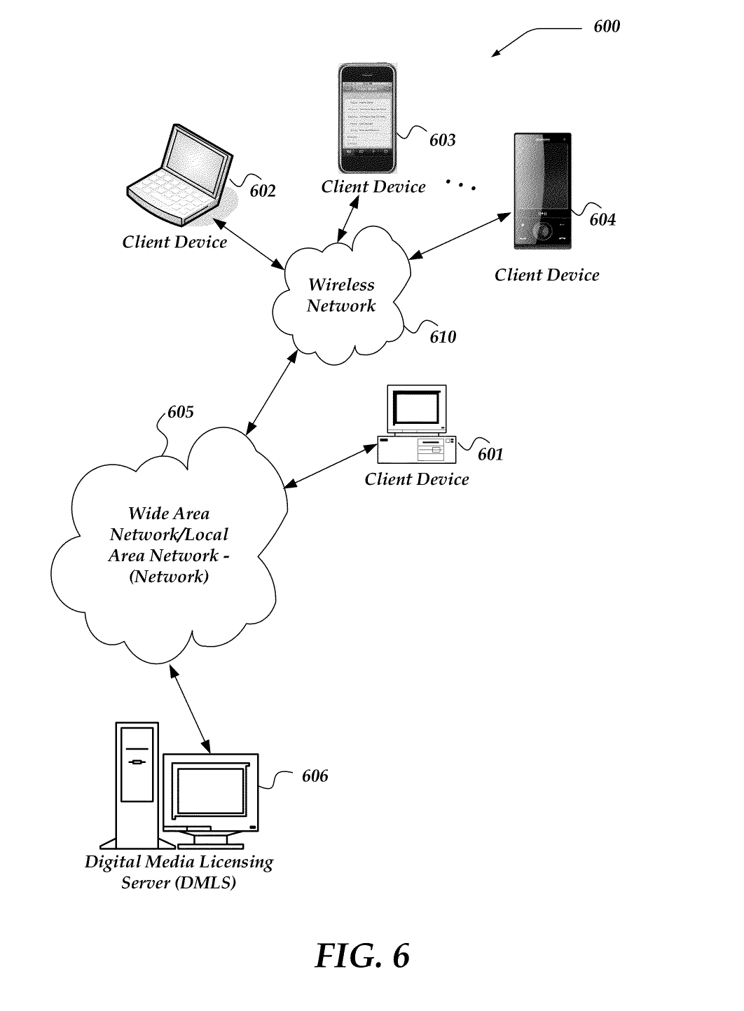

FIG. 6 is a system diagram that shows components of one exemplary environment in which the invention may be practiced. Not all of the components may be required to practice the invention, and variations in the arrangement and types of the components may be made without departing from the spirit or scope of the invention. As shown, system 600 of FIG. 6 includes wide area network (“WAN”)/local area network (“LAN”)-(network) 605, wireless network 610, client devices 601-604, and a digital media licensing server (DMLS) 506.

Customer computer 110 and rights holder computer 120 are embodiments of client devices 601-604 which may connect to either or both of wireless network 610 or network 605. Network 160 is an embodiment of wireless network 610, network 605, or a combination of both. Further, DMLS 150 is an embodiment of DMLS 606.

Generally, client devices 601-604 include any computing devices that are capable of receiving and sending messages over a network, such as network 605 or wireless network 610 including, network PCs, or the like. Client devices 601-604 include personal computers, multiprocessor systems, microprocessor-based or programmable consumer electronics, mobile devices such as mobile telephones, smart phones, display pagers, tablet computers, handheld computers, laptop computers, wearable computers, or the like.

A Web-enabled client device can communicate across the Web. It may include a browser application that is configured to receive and to send web pages, web-based messages, or the like. The browser application may send, receive and display graphics, text, multimedia, or the like, employing a network protocol such as Hypertext Transfer Protocol (HTTP) and/or wireless application protocol (WAP).

Client devices 601-604 may include client application programs that send and receive content to/from other computing devices. Examples of application programs include calendars, browsers and email clients and so forth. Client devices 601-604 may be configured to include an application program that enables a customer to search for, browse, select, negotiate pricing and pay for licenses media items in cooperation with a digital media licensing server such as DMLS 606. Client devices 601-604 may also be configured to include application programs used by a rights holder, a contributor of media items, or a customer for the purpose of licensing media items, in cooperation with a digital media licensing server such as DMLS 606, such as those described herein.

Wireless network 610 is configured to couple client devices 602-604 with network 605. Wireless network 610 may include any of a variety of wireless networks that provide a connection for client devices 602-604. Such networks may include mesh networks, wireless LAN (WLAN) networks, cellular networks, or the like. Wireless network 610 may further include network devices such as gateways routers, or the like. In essence, wireless network 610 may include virtually any wireless communication device or mechanism by which enables information to travel between client devices 602-604 or another computing device, network, or the like.

Network 605 is configured to couple DMLS 606, and client device 601 with other computing devices, including through wireless network 610 to client devices 602-604. Network 605 may include the Internet in addition to local area networks (LANs), wide area networks (WANs), direct connections, combinations thereof or the like.

DMLS 606 represents a network computing device that is configured to enable a content contributor to upload media items, a customer to search a digital media catalog, select media items, license and pay for selected media items, and a rights holder to negotiate prices for licenses. Devices that may operate as DMLS 606 include, but are not limited to personal computers, desktop computers, multiprocessor systems, microprocessor-based or programmable consumer electronics, network PCs, servers, network appliances, and the like.

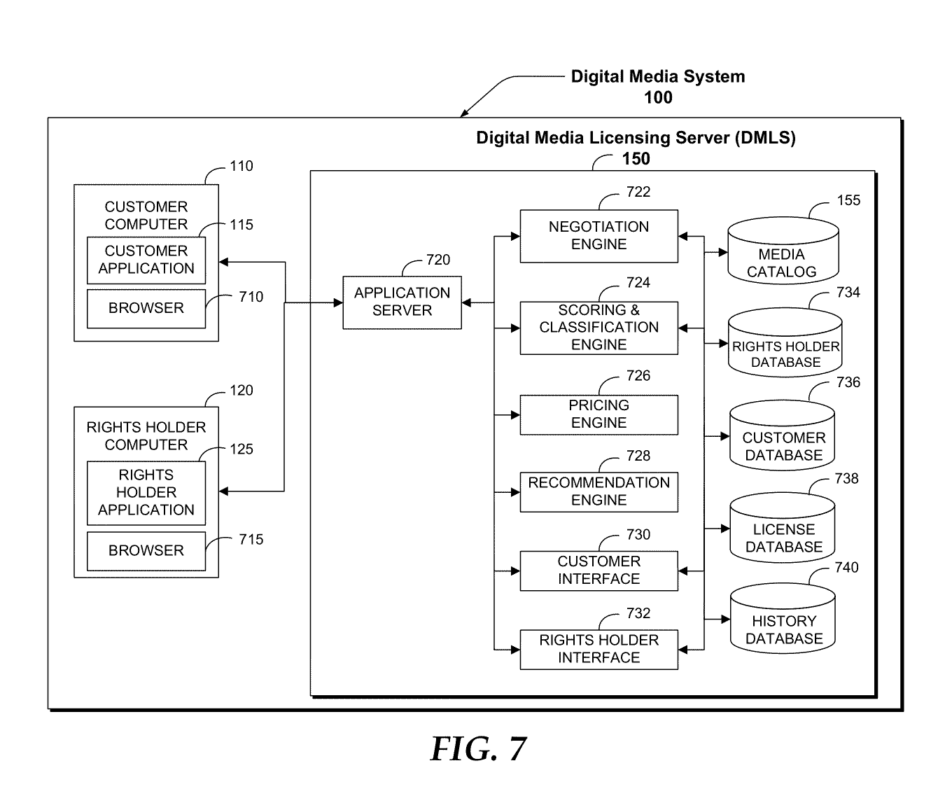

Although DMLS 606 is illustrated as a distinct network device, the invention is not so limited. For example, a plurality of network devices may be configured to perform the functions of DMLS 606. One such configuration is a “server farm” that includes multiple server computers operating cooperatively, each performing some of DMLS 606 server functions. One embodiment of the software modules that perform DMLS 606 server functions is described with reference to FIG. 7 below.

DMLS 606 functions may also be provided by a cloud computing facility in which the services, features and functions ascribed herein to DMLS 606 are delivered as a service over a network, such as the Internet, rather than by a specific server or cluster of servers.

DMLS 606 is capable of running application programs (“applications”). Applications that may be run by DMLS 606 include transcoders, database programs, customizable user programs, security applications, encryption programs, VPN programs, web servers, applications servers, account management systems, and so forth. Applications run by DMLS 606 may also include a customer interface, a rights holder interface, a database manager, and other applications and processes such as those described below in conjunction with FIG. 7.

DMLS 606 typically provides web services which include any of a variety of network services that are configured to provide content, including messages, over a network to another computing device. Thus, web services include for example, an application server, a web server, a messaging server, a File Transfer Protocol (FTP) server, a database server, a content server, or the like. Web services may provide the content including messages over the network using any of a variety of formats, including, but not limited to WAP, HDML, WML, SGML, HTML, XML, cHTML, xHTML, JSON, SOAP or the like. Web services may also include server-side scripting languages such as PHP, Python, and Java servlets. Web services may also include the server side of the Ajax web development method that enables a server to asynchronously respond to Ajax requests.

DMLS 606 includes data storage for storing program code and data. Data storage may include virtually any mechanism usable for storing and managing data, including but not limited to a file, a folder, a document, a web page or an application, such as a database, digital media including digital images and digital video clips, and the like.

Data storage may further represent a plurality of different data stores. For example, data storage may represent a media catalog such as media catalog 155, a customer database, a license database, and a history database and other databases such as those described below in conjunction with FIG. 7. Further, data storage may also include network storage or cloud storage in which the physical storage media is accessed across a network.

FIG. 7 is block diagram of the exemplary software modules of customer computer 110, rights holder computer 120 and digital media licensing server (DMLS) 150.

As discussed above with reference to FIG. 1, a customer interacts with customer computer 110 via customer application 115. In a preferred embodiment, customer application 115 is a Web application, that is it is written using standard Web programming languages such as HTML, JAVASCRIPT, and JAVA, and is executed by a browser 710 that runs in customer computer 110.

Browser 710 is typically a standard, commercially available, browser such as MOZILLA FIREFOX or MICROSOFT INTERNET EXPLORER. Alternatively, it may also be a client application configured to receive and display graphics, text, multimedia, and the like, across a network.

In one embodiment, browser 710 includes or works in conjunction with a client-side scripting engine that executes client-side scripting instructions written in a client-side scripting or programming language such as JAVASCRIPT® from ORACLE CORPORATION of Redwood Shores, Calif., the Java open source programming language, ACTIVEX® from the MICROSOFT CORPORATION of Redmond, Wash., and the like. In one embodiment, browser 610 is configured to use the Ajax (asynchronous JavaScript and XML or JSON) web development techniques that are used to create interactive web applications. Rather than referring to a specific standard or product, the term Ajax represents a broad group of web technologies that are used to implement a Web application that communicates with a server in the background, without interfering with the current state of a web page. Ajax enables browsers to asynchronously request incremental pieces of information from the server instead of whole pages. Ajax typically works with XML or JavaScript Object Notation (JSON) and a client-side scripting language such as JavaScript or ActiveX.

In one embodiment, when a customer accesses DMLS 150 using customer application 115, DMLS 150 downloads web pages in HTML format to browser 710 for viewing and interactive use. To perform some of the advanced client-side interactive functions, described with respect to FIGS. 3A-B, the web pages may include client-side scripting instructions. Typically, such client-side scripting instructions are embedded in HTML web pages and are interpreted or executed by a client-side scripting engine to perform functions not available through HTML commands such as advanced graphics, database access, and computations.

In one embodiment, JAVASCRIPT is used as a client-side scripting language. JavaScript is supported by most commercial browsers including MOZILLA FIREFOX, MICROSOFT INTERNET EXPLORER AND APPLE SAFARI. For purposes of specificity, all of the client-side capabilities described herein can be accomplished using browser 710 or browser 715 in conjunction with JAVASCRIPT Version 1.5, or greater.

In one embodiment, browser 710 issues hypertext transfer protocol (HTTP) requests to and receives HTTP responses from an application server 720 running in DMLS 150.

Application server 720 receives the HTTP requests and invokes the appropriate digital media licensing server software module to process the request. Application server 720 may be a commercially available application server that includes a web server that accepts and processes HTTP requests transmits HTTP responses back along with optional data contents, which may be web pages such as HTML documents and linked objects (images, or the like). In addition, browser 710 may use Ajax to issue requests for XML or JSON-coded information that is delivered asynchronously by application server 720. Henceforth, the term request message will refer to a message sent by browser 710 using HTTP, Ajax or other client-server communications method to DMLS 150. And a response message will refer to a message sent in response, typically using the same communications method, by application server 720 running in DMLS 150.

Application server 720 establishes and manages customer and rights holder sessions. Typically application server 720 assigns each session a unique session id. A session lasts from the time a user (i.e. a customer or rights holder) logs in, or accesses DMLS 150, until the time the user logs out or stops interacting with DMLS 150 for a specified period of time. In addition, application server 720 typically manages server applications and provides database connectivity.

Upon request by browser 710, application server 720 downloads to customer computer 110 or rights holder computer 120 the HTML, JavaScript and other browser-executable code that make up customer application 115 or rights holder application 125, respectively.

DMLS 150 includes a negotiation engine 722, a scoring and classification engine 724, a pricing engine 726, a recommendation engine 728, a customer interface 730, and a rights holder interface 732. DMLS 150 further includes five databases: a media catalog 755, a contributor database 734, a customer database 736, a license database 738, and a history database 740. It may be appreciated that each of the abovementioned databases may be implemented as one or more computer files spread across one or more physical storage mechanisms. In one embodiment, each of the abovementioned databases is implemented as one or more relational databases and is accessed using the structured query language (SQL).

Negotiation engine 722, scoring and classification engine 724, pricing engine 726, recommendation engine 728, customer interface 730, and rights holder interface 732 may each include, or may share the use of, a commercial database management system (DBMS) to access and search for data and objects that reside in the database. In a preferred embodiment, the DBMS is a relational DBMS (RDBMS) such as ORACLE® from the Oracle Corporation, SQL SERVER from the Microsoft Corporation, or the like. However, other database managers may also be used. In addition to a RDBMS, a standard data extraction tool may be included that simplifies access to relational databases, enabling a developer to express queries visually or in a simplified manner, rather than using structured query language (SQL).

Negotiation engine 722 is responsible for managing the sequence of messages and user interfaces displayed during a negotiation between a customer and one or more rights holders for a license to a media item, such as described with reference to FIGS. 4A-C. For offers and counteroffers made by a customer for use of a media item, negotiation engine 722 calculates the amount payable to each rights holder in the media item under the allocation method defined for the media item. Negotiation engine 722 supports a variety of allocation methods, including commonly used methods such as MFN. Further, negotiation engine 722 may use pricing engine 726 to calculate recommended offers and counteroffers and include these in the appropriate customer and rights holder user interfaces.

Scoring and classification engine 724 computes numerical scores of media items based on data elements such as those presented in Table 5. Scoring and classification engine 724 may obtain historical licensing information from license database 738. Also, scoring and classification engine 724 may obtain information from external data sources 140 such as from Web search engines, social media systems, industry websites and databases whose content is either publicly available or available on a paid basis. For example, in one embodiment scoring and classification engine 724 is capable of downloading and extracting chart information for specific media items, typically songs, from the Billboard.com website that provides a variety of music charts. Scoring and classification engine 724 stores information from external data sources 140 in history database 740.

Pricing engine 726 retrieves prices and calculates prices that are provided by customer interface 730 and by rights holder interface 732 to customers and rights holders respectively. It also provides pricing guidance, i.e. pricing recommendations, for offers and counteroffers made by customers and rights holders. In calculating pricing guidance, pricing engine 726 uses data inputs elements such as those presented in Table 6. In one embodiment, it performs the method described with reference to FIG. 5A.

Recommendation engine 728 generates song and artist recommendations. In one embodiment, it performs the method described with reference to FIG. 5B.

Customer interface 730 responds to requests from customer application 115, i.e. it performs the back-end server processing. Customer interface enables a customer to search, browse, select, and license, negotiate prices for and download digital media items listed in media catalog 155. Customer interface 730 responds to requests for information about media elements listed in media catalog 155 by querying media catalog 155. Customer interface 730 responds to requests for license information for one or more media assets by querying a license database 738 for license information regarding the media items referenced in the request. Such requests for license information may include, inter alia, license options, availability for licensing, and licenses in force. Customer interface 730 responds to requests for prices. Customer interface 730 obtains price information for one or more media items from pricing engine 740. In one embodiment, customer interface 730 manages an electronic cart for one or more customers. Customer interface 730 responds to request messages to update information about electronic carts that it manages. Customer interface 730 provides user interface elements and information to customer application 115. In one embodiment, upon request, customer interface 730 transmits web pages, scripts and other elements that comprise customer interface 200, 220, and 240 to customer computer 110 for use by customer application 115.

Rights holder interface 732 responds to requests from rights holder application 125, i.e. it performs the server processing corresponding to the client processing performed by rights holder application 125. Rights holder interface enables a rights holder to log in, review and edit information about media items in which they hold a right, review and edit their account settings, respond to offers from customers and to make counteroffers. Rights holder interface 732 provides user interface elements and information to rights holder application 125. In one embodiment, upon request rights holder interface 732 transmits web pages, scripts and other elements that comprise rights holder interface 300 and rights holder interface 320 to rights holder computer 120 for use by rights holder application 125.

In the discussion hereinbelow concerning databases it may be appreciated by one skilled in the art that each database may be implemented as one or more database files, alternatively two or more of the databases may be implemented as a single database file. Further the term database may refer to a relational database file that is accessed by a relational database manager or it may implemented as a B-tree, R-tree, spreadsheet, flat file, comma separated value any other type of suitable data structure stored within one or more computer files.

Media catalog 155 stores records for each digital media item listed in the catalog. The records typically include metadata that describe qualities of the media items. In one embodiment, each media item is described by a database record that includes fields such as those listed and described in Table 11.

In another embodiment, the fields listed in Table 11 are stored as a relational table using a relational database management system where the Unique ID field serves as the key. In one embodiment, a media item such as a digital image, or digital music file, may be stored within the database or databases that implement media catalog 155, or separately, e.g. in the local file system, or in remotely accessible network storage. Alternatively, DMLS 150 may not store or manage access to the media item at all. The media item may be stored by content provider 130 or by another entity in which case the Access Info field of media catalog 155 provide information about how to access the media item.

Rights holder database 734 stores a rights holder record for each rights holder. The rights holder record includes information such as name and contact information. Rights holder database 734 may also include information about rights holder preferences, such as whether they. A contributor record includes the contributor's name, contact information and a unique identifier.

Customer database 736 stores a customer record for each registered customer. A customer record includes inter alia name, contact information and means of payment information. Name and contact information is typically obtained during registration. Typically, a customer registers with DMS 100 prior to completing his/her first purchase.

License database 738 stores information about the license terms for each media items, as well as identifies each rights holder in the media item and their percentage ownership and any additional information necessary to enable a customer 170 to license the media item. License database 736 also stores any special information about individual media items. For example, a media item, such as a photo of a famous actor, may be prohibited from being used for an advertisement for an alcoholic beverage. License database 736 may also store license price information for individual media items and/or price information for price tiers to which individual media items are assigned. License database 738 may also store historical licensing information such as the price of the license, dates associated with various steps in the licensing process, and the amount of the counteroffers made by rights holders.

History database 740 stores historical information for media items, including information obtained from external data sources 140 such as sales, social media, public interest and chart data for individual media items.

The above specification, examples, and data provide a complete description of the manufacture and use of the composition of the invention. Since many embodiments of the invention can be made without departing from the spirit and scope of the invention, the invention resides in the claims hereinafter appended.

TABLE 1
Price Ranges, Messages and Actions

| | | Will Offer |
|---|---|---|
| Price range | Message | Be Made? |
| 0 > Offer <= .5RO | Sorry, that's just too low | No |
| .5RO < Offer <= .75RO | That's a little dicey | Yes |
| .75 < Offer < RO | Our fingers are crossed. | Yes |
| RO | The recommended offer is <RO> | Yes |

TABLE 2
Calculate Splits for Initial Offer By Customer
Performed at Step 414 of FIG. 4A

| 1. Receive initial customer offer: $1000 | | |
|---|---|---|
| 2. Calculate clearance agency margin (fee) of 30% - $300 | | |
| 3. Calculate amount for Rights Holders (70%) - $700 | | |
| 4. Calculate equal MFN splits between Master and Publishers | | |
| (Collectively) | | |
| Master | $350 | |
| Pub 1 | $350 | |
| Pub 2 | | |
| 5. Calculate splits between each publisher. | | |
| Master | 100% | $350 |
| Pub 1 | 70% | $245 |
| Pub 2 | 30% | $105 |

TABLE 3
Calculate Splits for Counteroffer made by Rights Holders.
(Performed at Step 434 of FIG. 4B)

| 1. Record all counteroffers: | | |
|---|---|---|
| Master | $525 | |
| Pub 1 | $300 | |
| Pub 2 | $150 | |
| 2. Select highest counteroffer, and calculate rights holders' shares: | | |
| Master | 100% | $525 |
| Pub 1 | 70% | $367.5 |
| Pub 2 | 30% | $157.5 |

3. Calculate clearance agency margin (fee): $450
4. Calculate amount of counteroffer to customer: $1500

TABLE 4
Calculate Splits for Counteroffer made by Customer.
(Performed at Step 442 of FIG. 4B)

1. Receive customer counteroffer: $1200
2. Calculate clearance agency margin (fee) of 30%: $360
3. Calculate amount for Rights Holders (70%): $840
4. Calculate MFN splits between Master and Publishers (Collectively):

| | |
|---|---|
| Masters | $420 |
| Publisher 1 | $420 |
| Publisher 2 | |

5. Calculate splits between Master and Publishers:

| | | |
|---|---|---|
| Master | 100% | $420 |
| Pub 1 | 70% | $294 |
| Pub 2 | 30% | $126 |

TABLE 5
Data Elements Used to Score Media Items

| Name of Element | Description |
|---|---|
| Charting History | The ranking of media items within various industry |
| | charts may be used. These are typically lists of |
| | sales of media items for a fixed time period such as |
| | a week, month or year. In one embodiment, each |
| | different chart is assigned an importance |
| | weighting. A song's highest position and the |
| | length of time is remains on each chart are |
| | captured and given numeric values. These values |
| | may then weighted according to the chart and |
| | according to the album on which the song was |
| | released. Examples of industry charts that are |
| | available on the Web include Rock Chart, Hot |
| | Country Chart, Smooth Jazz Chart and Christian |
| | Chart published by Billboard, Inc. of NY, NY on its |
| | Billboard.com website. |
| Artist Tier | Artists may be categorized into tiers based on |
| | lifetime sales or based on other criteria. For |
| | example, a specific number of points may be |
| | awarded for each tier. Such information is |
| | available from public websites. |
| Current Public | Measures of the interest of the public in a media |
| Interest | item or artist. In one embodiment, current public |
| | interest is estimated using the average number of |
| | web searches on the name or title of the media |
| | item per month across one or more search |
| | engines. |
| Popularity of | Popularity of Related Social Media is a |
| Related Social | measurement of popularity of the media item, a |
| Media | collection to which the media item belongs, or the |
| | artist that created the media item is estimated by |
| | data from several of the top social media systems, |
| | such as FACEBOOK and GOOGLE+. In one |
| | embodiment, the number of fans or followers |
| | associated with the media item, or the artist, may |
| | be used to rank the media item relative to this |
| | element. |
| License History | The licensing history, also referred to as clearance |
| | history, of the media item may be used. For |
| | example, an average price of licenses granted to |
| | the media item for the same commercial use and |
| | for the same specified terms (time period, |
| | geography, etc.) may be used. The clearance |
| | history of similar media items may also be used. |
| | The license history of a media item may be |
| | assigned a numerical value. For example, license |
| | history may be represented as a cumulative total |
| | of license fees paid for the media item; a weighted |
| | total based on the date of license, or the like. |
| License history of | The licensing, or clearance, history, of other media |
| media items with | items, for the same commercial use, with the same |
| the same rights | rights holders may be taken into account. For |
| holders | example, it may be the case a certain rights holder |
| | always demands at least $500 in licensing fees to |
| | use a song for a corporate presentation, regardless |
| | of which song it is. |

TABLE 6
Example Classification Table.

| Class | Range of Scores |
|---|---|
| A | score >= 1000 points |
| B | 500 points >= score < 1000 points |
| C | score < 500 points |

TABLE 7
Base Prices for a License for Internal Company Meeting

| Class | Base Price |
|---|---|
| A | $149 |
| B | $114 |
| C | $79 |

TABLE 8
Multipliers

| Term | Case | Multiplier |
|---|---|---|
| Audience Size | Up to 10 | 1.00 |
| | 10 to 25 | 1.25 |
| | up to 50 | 1.50 |
| Duration | Up to 1 Month | 1.00 |
| | 1 to 3 Months | 1.50 |
| | 3-6 Months | 1.75 |
| | 6 to 12 Months | 2.00 |
| Territory | 1 Country | 1.00 |
| | World Wide | 2.00 |

TABLE 9
Text Message For Varying Levels of Counteroffers

| Counteroffer* | Text Message Displayed to Rights Holder |
|---|---|
| 101-110% | Likelihood of customer acceptance is very strong |
| 111-120% | Likelihood of customer acceptance is strong |
| 121-130% | Likelihood of customer acceptance is medium |
| 131-140% | Likelihood of customer acceptance is weak |
| Above 140% | Likelihood of customer acceptance is very weak |

*Stated as a percentage of the corresponding customer offer.

TABLE 10
Factors Taken Into Account In Determining Recommended Media
Items and Artists

| Factor | Description |
|---|---|
| Budget | The customer's budget for purchasing licenses for their |
| | project. (Note that the budget may be estimated as |
| | the customer offer price.) |
| Rights holders | The historic responsiveness to like requests by the |
| license history | rights holders in the media item. |
| Pre-approval | Has the use specified by the customer for the media |
| status | item been pre-approved by the rights holders. |

TABLE 11
Media Catalog Fields For A Media Item

| Name Of Field | Description |
|---|---|
| Unique ID | Unique identifier for the media item. Used as key to |
| | access database information about the media item. |
| Title | Title of media item. The title is typically displayed to the |
| | customer. |
| Artist | Person or persons that created the media item. |
| Attributes | A list of attributes or qualities possessed by the media |
| | item, such as media type (photography, illustration, |
| | etc.), color model (color, black and white, etc.), aspect |
| | ratio (vertical, horizontal), size, resolution, tempo |
| | (song), mood (song), genre, theme, release date. |
| Keywords | List of keywords used for searching. |
| Access Info | Information about how to access the corresponding |
| | media item |

What is claimed is:

1. A computer-implemented method for licensing a media item by a customer for a commercial use, comprising:
maintaining by a digital media licensing server (i) a catalog of media items that are available to be licensed by a customer for a commercial use, and (ii) a database of records for each media item, said records including information about each rights holder in the media item;
receiving a designation of a media item from the catalog from a customer computer;
providing a customer interface to the customer computer that enables a customer to specify an offer to license the selected media item for a commercial use;
receiving an offer from the customer computer, said offer including (i) a designation of a commercial use and (ii) an offer price;
electronically providing to at least one rights holder in the media item information about the offer, said information including the designated commercial use and the offer price;
electronically receiving from at least one rights holder in the media item at least one counteroffer price in response to said offer price; and
determining a collaborative counteroffer price based on the at least one counteroffer price; and
electronically providing said collaborative counteroffer price to the customer.

2. The method of claim 1 further comprising:
determining a recommended offer price for the media item based on the designated commercial use; and
providing via the customer interface the recommended offer price.

3. The method of claim 1 wherein electronically providing said collaborative offer price is provided to the customer by said customer interface.

4. The method of claim 3 further comprising enabling the customer via said customer interface:
to accept said collaborative counteroffer price; and
to electronically pay for the license to the media item.

5. The method of claim 1 wherein electronically providing to at least one rights holder in the media item consists of providing a graphical user interface to a rights holder computer, said graphical user interface enabling the at least one rights holder to specify a counteroffer price.

6. The method of claim 5 wherein said graphical user interface further provides an indication of the likelihood that the customer will accept the specified counteroffer price.

7. The method of claim 1 wherein said determining a collaborative counteroffer price consists of selecting the highest counteroffer price from among the at least one counteroffer price.

8. A computer-implemented method for recommending a media item for licensing by a customer, comprising:
maintaining by a digital media licensing server (i) a catalog of media items that are available to be licensed by a customer for a commercial use, and (ii) a database of records for each media item, said records further including historical information about the popularity of the media item;
providing a customer interface to a customer computer that enables a customer to specify an offer to license a selected media item for a commercial use;
receiving from the customer computer a designation of (i) a media item from the catalog and (ii) a commercial use for the media item;
obtaining for the media item at least one measure of popularity from an external data source;
determining a score for the media item based on historical information about the popularity of the media item;
calculating a recommended offer price based on the media item's score and on its designated commercial use;
providing the recommended offer price to the customer computer.

9. The method of claim 8 wherein said media item is a song and at least one of said at least one measure of popularity is selected from the group consisting of recent sales of the media item, keyword searches using the name of the media item as the search term, the peak position attained by the media item on an industry chart over a specified time interval, and the number of weeks the media item remained on an industry chart during a specified time interval.

10. The method of claim 9 further comprising updating the information about the popularity of the media item with information about the position of the song on a music industry chart.

11. The method of claim 10 wherein said music industry chart is published on a web page.

12. The method of claim 8 wherein said media item is a song and said records of information about the media item further include a designation of the artist of the media item, further comprising obtaining at least one measure of the sales history of a plurality of the artist's media items, wherein said determining a score is further based on the at least one measure of the sales history of a plurality of the artist's media items.

13. The method of claim 8, wherein the offer also includes one or more additional license terms and wherein said determining the score is further based on said additional license terms.

14. The method of claim 13, wherein the additional license terms are selected from the group consisting of an audience size, the time period during which the license will be in force, a geographic area of coverage, and whether or not the license will be exclusive.

15. A computer-implemented method for recommending a media item for licensing by a customer, comprising:
maintaining by a digital media licensing server (i) a catalog of media items that are available to be licensed by a customer for a commercial use, and (ii) a database including a record for each media item, said records including metadata specifying qualities of the media item;
providing a customer interface to a customer computer that enables a customer to specify an offer to license a selected media item for a commercial use;
receiving from the customer computer a designation by a customer of (i) a media item from the catalog and (ii) a commercial use for the media item;
determining at least one media item to recommend to the customer, said determining based on (i) the qualities of the designated media item, (ii) the designated commercial use, and (iii) the likelihood that the designated media item will be cleared for the designated commercial use; and
providing information about the at least one recommended media item to the customer computer.

16. The method of claim 15 wherein the designated media item is a song and said qualities of the media item include at least one member from the group consisting of genre, theme, mood, release date, artist, and tempo.

17. The method of claim 15 wherein said records further include the license history of the media item, and wherein the likelihood that the designated media item will be cleared for the designated commercial use is based on its license history.

18. The method of claim 15 wherein said records further include, information about rights holders in the media item, and an indication as to whether the media item has been pre-approved for licensing for the designated commercial use by its rights holders, and wherein the likelihood that the designated media item will be cleared for the designated commercial use is based on whether the media item has been pre-approved for licensing for the designated commercial use by its rights holders.
